(19) United States
(12) Patent Application Publication
(10) Pub. No.: US 2018/0345872 A1
(43) Pub. Date: Dec. 6, 2018

(54) ADJUSTABLE TRUCK BED EXTENDER

(71) Applicant: Yakima Products, Inc., Lake Oswego, OR (US)

(72) Inventors: Charles Kraeuter, Portland, OR (US); Jason Attfield Sagen, Portland, OR (US)

(73) Assignee: Yakima Products, Inc., Lake Oswego, OR (US)

(21) Appl. No.: 15/996,301

(22) Filed: Jun. 1, 2018

Related U.S. Application Data
(60) Provisional application No. 62/513,900, filed on Jun. 1, 2017.

(51) Int. Cl. B60R 9/06

(52) U.S. Cl. CPC B60R 9/06; B62D 33/02

(57) ABSTRACT

An adjustable truck bed extender is disclosed, including a hitch mount configured for attachment to a vehicle, and a mast structure having a first end pivotally coupled to the hitch mount. The truck bed extender further includes a crossbar member coupled to a second end of the mast structure, perpendicular to the mast structure. A length of the mast structure and an angle of the mast structure relative to the hitch mount are separately adjustable.

### CROSS-REFERENCES

This application claims the benefit under 35 U.S.C. § 119(e) of the priority of U.S. Provisional Patent Application Ser. No. 62/513,900 filed Jun. 1, 2017, the entirety of which is hereby incorporated by reference for all purposes.

### FIELD

This disclosure generally relates to cargo-carrying accessories for vehicles. Specifically, it relates to hitch mounted truck bed extenders.

### INTRODUCTION

Many pickup trucks are used to transport loads that exceed the length of the flat bed of the truck. Such loads may include materials such as lumber and pipe, or recreational equipment such as canoes and long touring kayaks. Additional support is needed for safe transport, and one solution is a hitch-mounted truck bed extender. However, cargo may vary in size and shape, and some cargo may be more effectively carried in combination with a cab roof rack or bed rail rack. Existing truck bed extenders often include only two or three height settings, or are not adjustable at all. An extender that can be adjusted for a range of cargo dimensions and/or to cooperate with other cargo supports is accordingly desirable.

### SUMMARY

The present disclosure provides systems, apparatuses, and methods relating to supporting cargo and carrying cargo on a vehicle. In some examples, a cargo support rack for a vehicle may include a hitch mount configured for attachment to a vehicle, and a mast structure having a first end pivotally coupled to the hitch mount. The rack may further a crossbar member coupled to a second end of the mast structure, perpendicular to the mast structure. A length of the mast structure and an angle of the mast structure relative to the hitch mount may be separately adjustable.

In some examples, a rack for carrying cargo on a vehicle may include a tongue member having a long axis, a proximal end portion configured for engaging a hitch receiver on the rear of a truck, and a distal end portion connected to a pivot assembly. The rack may further include a mast structure having a long axis, a proximal end portion, and a distal end portion, with the proximal end portion connected to the pivot assembly. A crossbar may be connected to the distal end of the mast structure.

In some examples, a rack for carrying cargo on a vehicle may include a tongue member having a long a proximal end portion configured for engaging a hitch receiver on the rear of a truck, and a distal end portion. A mast structure may be connected to the tongue member, the mast structure having a long axis, a proximal end portion, and a distal end portion connected to a crossbar. The mast structure may include first, second, and third telescopically engaged tube portions. The first tube portion may be pivotally connected to the pivot assembly, the second tube member may be telescopically engaged with the first tube member, and the third tube member may be telescopically engaged with the second tube member.

Features, functions, and advantages may be achieved independently in various examples of the present disclosure, or may be combined in yet other examples, further details of which can be seen with reference to the following description and drawings.

### BRIEF DESCRIPTION OF THE DRAWINGS

FIG. 1 is an isometric view of an exemplary truck bed extender attached to a truck, with three positions of the truck bed extender indicated.

FIG. 2 is a side view of the truck bed extender of FIG. 1, adjusted to a shortest length and a second angular orientation.

FIG. 3 is a front view of the truck bed extender of FIG. 1, adjusted to an intermediate length.

FIG. 4 is an exploded isometric view of the truck bed extender of FIG. 1.

FIG. 5 is a cross-sectional view of a portion of the mast of FIG. 3, along line 5-5.

FIG. 6 is a partially transparent view of the pivot assembly of FIG. 2, with one plate omitted.

### DESCRIPTION

Various aspects and examples of an adjustable truck bed extender, as well as related systems and methods, are described below and illustrated in the associated drawings. Unless otherwise specified, an adjustable truck bed extender according to the present teachings, and/or its various components may, but are not required to, contain at least one of the structure, components, functionality, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

### Overview

In general, an adjustable truck bed extender according to the present teachings may include first and second elongate members, coupled together approximately perpendicular to one another. A central portion of the second elongate member may be fixed to a first end of the first elongate member. The truck bed extender may be configured for attachment to a rear portion of a vehicle, such as a truck, van, or trailer. For example, the truck bed extender may have a hitch mount appropriate for connection to a hitch. A second end of the first elongate member may be coupled to the hitch mount.

When the truck bed extender is attached to a vehicle, the first elongate member may extend generally parallel to a plane defined by the longitudinal axis and/or direction of travel of the vehicle, and/or may extend in a plane bisecting the vehicle. The second elongate member may extend generally perpendicular to the longitudinal axis and/or direction of travel of the vehicle, and to the plane defined thereby.

The truck bed extender may be configured to support cargo in cooperation with the vehicle. For example, when attached to a pickup truck the second elongate member of the truck bed extender may support an end portion of cargo carried in the bed of the truck. For another example, cargo may be supported between the second elongate member of the truck bed extender and a crossbar or roof rack on the cab of a pickup truck.

The first elongate member may have a length and an angular orientation relative to a connective component of the truck bed extender, such as a hitch mount. In some examples, the angular orientation of the first elongate member may be defined relative to the longitudinal axis and/or direction of travel of the vehicle. In some examples, the angular orientation of the first elongate member may be defined by an angle between a long axis of the first elongate member and a long axis of the connective component. The length and angular orientation of the first elongate member may be separately adjustable. The first elongate member may be adjustable between a plurality of discrete lengths, and may be adjustable between a plurality of discreet angles.

The first elongate member may be telescopically extendable. The member may include first and second hollow components, slidably received in one another. The first and second components may be selectably fixed relative to one another by a fastener extending through the first component and a portion of the second component received in the first component. The first elongate member may be secured at a length by fixing the first and second components relative to one another.

The first elongate member may be pivotally coupled to the hitch mount, and may pivot about a transverse member. The transverse member may extend perpendicular to the longitudinal axis and/or direction of travel of the vehicle. The first elongate member may be secured at an angle by a fastener extending through the mast and through a pivot assembly.

The truck bed extender may be adjustable between a plurality of positions. Each position may be a combination of an angle of the plurality of discreet angles and a length of the plurality of discrete lengths. The truck bed extender may be adjustable by pivoting and extension of the first elongate member.

The truck bed extender may be configured for quick and highly customizable adjustment. Adjustability in two dimensions may greatly increase the number of positions available, while allowing simple mechanisms that are light, inexpensive, and easy to operate. The truck bed extender may also be adjustable without the use of tools, allowing a user to change positions at the time of loading.

### Illustrative Truck Bed Extender

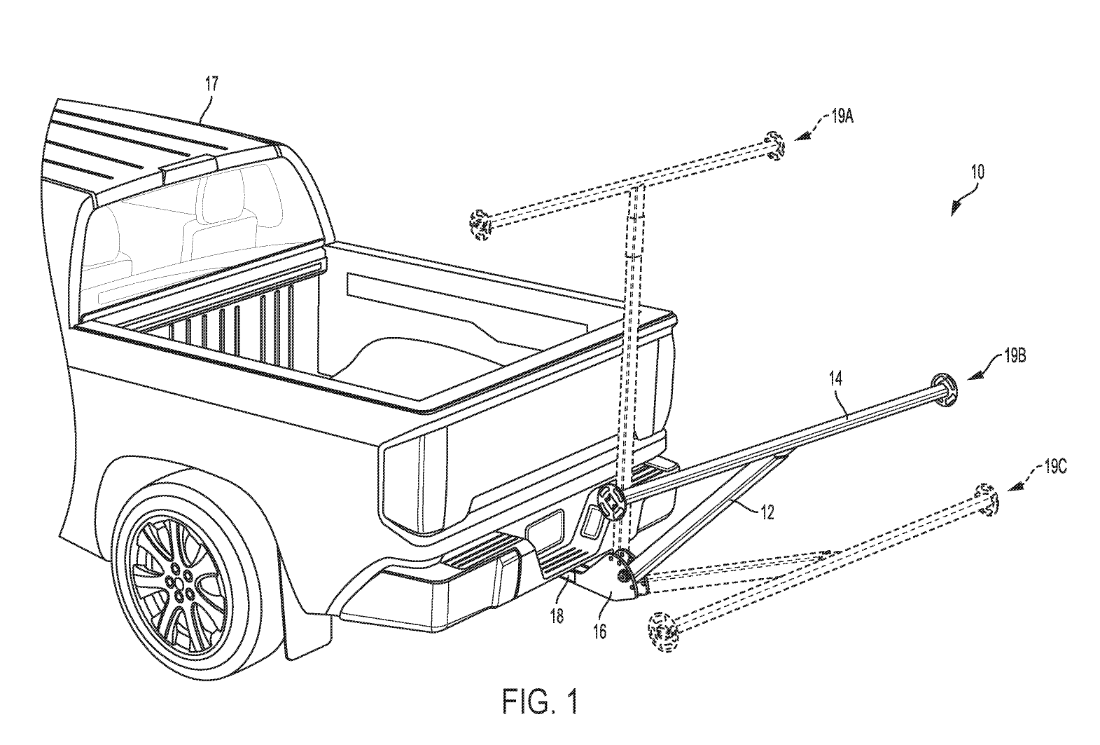

FIG. 1 shows an example of an adjustable truck bed extender generally indicated at 10, including a mast 12, a crossbar 14, a pivot assembly 16, and a hitch mount 18. Truck bed extender 10 may also be referred to as a cargo support rack, a hitch-mounted rack, and/or a cargo support. The hitch mount is connected to a hitch receiver of a pickup truck 17. In the present example, the hitch mount includes a tongue member with a long axis, configured to engage a hitch receiver on the rear of truck 17. In some examples extender 10 may be used with other cargo-carrying vehicles having a hitch receiver, such as a van or utility vehicle. Extender 10 is depicted in 3 illustrative positions 19A, 19B, and 19C. The positions be may be referred to as cab height 19A, rail height 19B, and bed height 19C.

Crossbar 14 is configured to support an end of one or more items transported by the truck. Transported items may be any vehicle cargo, including but not limited to recreational equipment such as kayaks, building materials such as lumber, and construction equipment such as ladders. When extender 10 is in cab height position 19A, cargo may be supported between crossbar 14 and a crossbar or roof rack of the cab of truck 17. When extender 10 is in rail height position 19B, cargo may be supported between crossbar 14 and a bed rack or other structure mounted to the rails of the truck bed. When extender 10 is in bed height position 19C, cargo may be supported between crossbar 14 and the bed of truck 17. Crossbar 14 and extender 10 may also be used to support cargo in any effective manner. For example, loads susceptible to sliding may be supported at an angle between the truck bed and crossbar 14 with extender 10 in rail height position 19B.

In addition to the 3 depicted positions 19A-C, extender 10 is adjustable between a plurality of discrete positions. Mast 12 is connected to hitch mount 18 by pivot assembly 16, which allows the mast to pivot between a plurality of discrete angular orientations. Mast 12 also telescopes between a plurality of discrete length settings. A combination of the two adjustments allows a wide range of possible positions of extender 10.

Each position may be associated with a height of crossbar 14 relative to truck 17, and a reach of the crossbar away from the end of the truck. Separately adjusting the angular orientation and length setting of mast 12 may allow selection of a position closely approximating a desired height and/or reach of crossbar 14. For example, the height of the crossbar may be selected to match a second cargo support such as a roof or bed rack. For another example, the reach of the crossbar may be selected to match a length dimension of some cargo to provide adequate support at a distal end of the cargo.

Truck bed extender 10 is configured to be adjustable without the use of tools. Adjustments may be made quickly, at the time of loading cargo. The extender may also be left connected to truck 17 when not in use, in a vertical or 0-degree angular orientation and a shortest length setting. Such a position may be referred to as a storage position. All parts of extender 10 may remain connected in all positions, including storage and cargo-carrying positions. This may eliminate the risk of separately stored parts being misplaced.

Truck bed extender 10 may be permanently connected to one vehicle, or may be transferred between vehicles. The plurality of positions may allow the extender to be compatible with a range of vehicles having a range of dimensions. For instance, in the depicted example, crossbar 14 is at approximately the same height as the rails of the bed of truck 17 when extender 10 is in position 19B. When attached to another truck, crossbar 14 may be higher than the bed rails in position 19B. Instead, another of the plurality of positions may correspond to the bed rail height.

In the present example, truck bed extender 10 is adjustable between 4 discrete angular orientations and 14 discrete length settings. Accordingly, the extender is adjustable between 56 discrete positions. Extender 10 may include any number of discrete angular orientations and/or discrete length settings. In some examples, the extender may be designed for a selected truck model or a standard range of truck dimensions, and may be adjustable to a limited number of discrete positions corresponding to the selected range of dimensions. In some examples, the extender may be adjustable to greater plurality of positions to allow fine-tuning of the height and reach of crossbar 14.

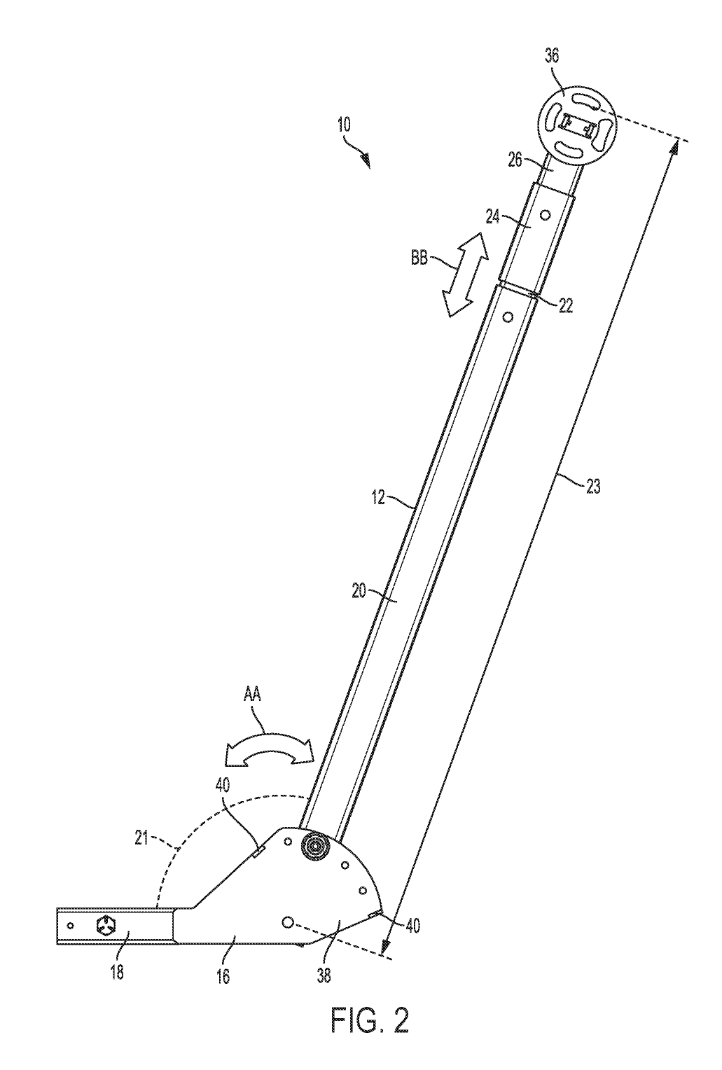

FIG. 2 shows a side view of truck bed extender 10, indicating a pivoting adjustment AA of the angular orientation of the extender, and a telescoping adjustment BB of the length setting of the extender. Pivoting adjustment AA changes an angle 21 between mast 12 and hitch mount 18. Angle 21 may also be described as between a long axis of the mast and a long axis of the hitch mount. Telescoping adjustment BB changes a length 23 of mast 12, measured from a pivot point to a distal side of crossbar 14.

Mast 12 is made up of multiple components, which allow telescoping adjustment BB. A main mast sleeve 20 is coupled to pivot assembly 16, and an extender insert 22 is slidably received in the mast sleeve. At a top, and/or distal end of the extender insert, an extender sleeve 24 is fixed to extender insert 22 and configured to slidably receive crossbar support 26. The crossbar support is fixed to an underside of crossbar 14, perpendicular to a lateral extent of the crossbar.

Each of main mast sleeve 20, extender insert 22, extender sleeve 24, and crossbar support 26 is hollow and tubular, with a generally rectangular cross-sectional shape. The components of mast 12 may have any effective shape, and may comprise any material of sufficient strength to support cargo. In the present example, the mast comprises extruded aluminum. Mast 12 may be described as including first, second and third telescopically engaged tube members.

Components of mast 12 are sized to allow sliding motion between received and receiving components. In some examples, additional structures such as bearings or wheels may facilitate translational motion. In some examples, components of mast 12 may be inseparable. For instance, extender insert 22 may include a boss on an outer surface, the boss being slidably received in a closed track on an inner surface of main mast sleeve 20. The extender insert may be thereby prevented from sliding free of the main mast.

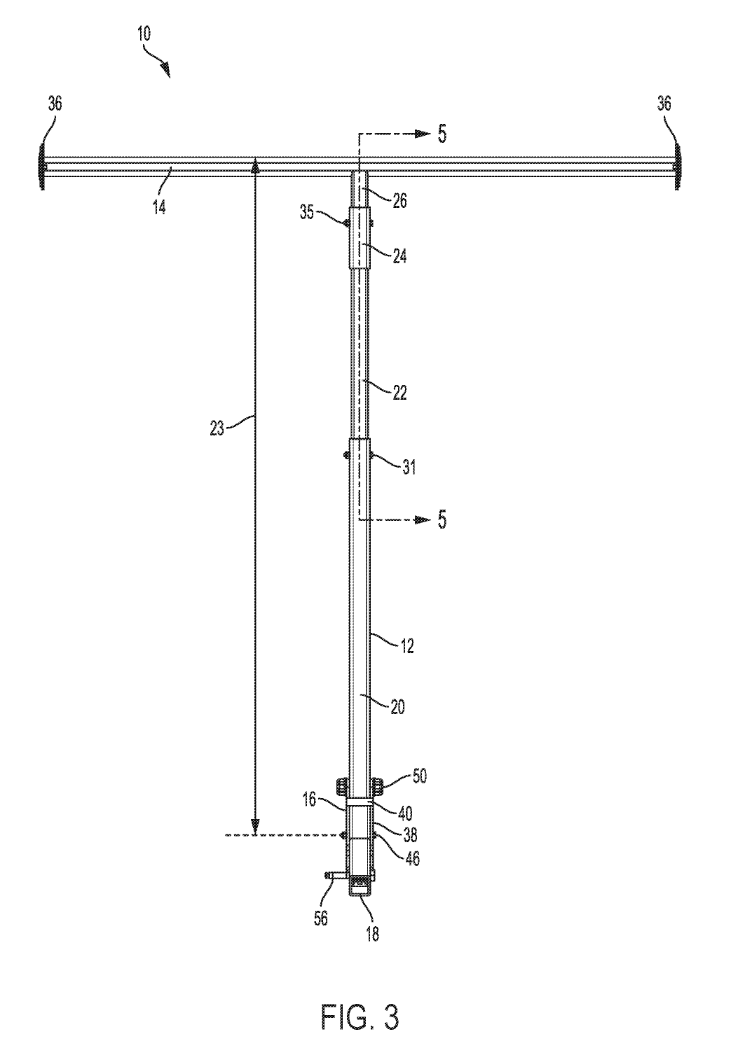

FIG. 2 shows truck bed extender 10 in a shortest length setting, with extender insert 22 fully received in main mast sleeve 20 and a majority of crossbar support 26 received in extender sleeve 24. FIG. 3, a front view, shows the extender in an intermediate length setting with extender insert 22 only partially received in main mast sleeve 20.

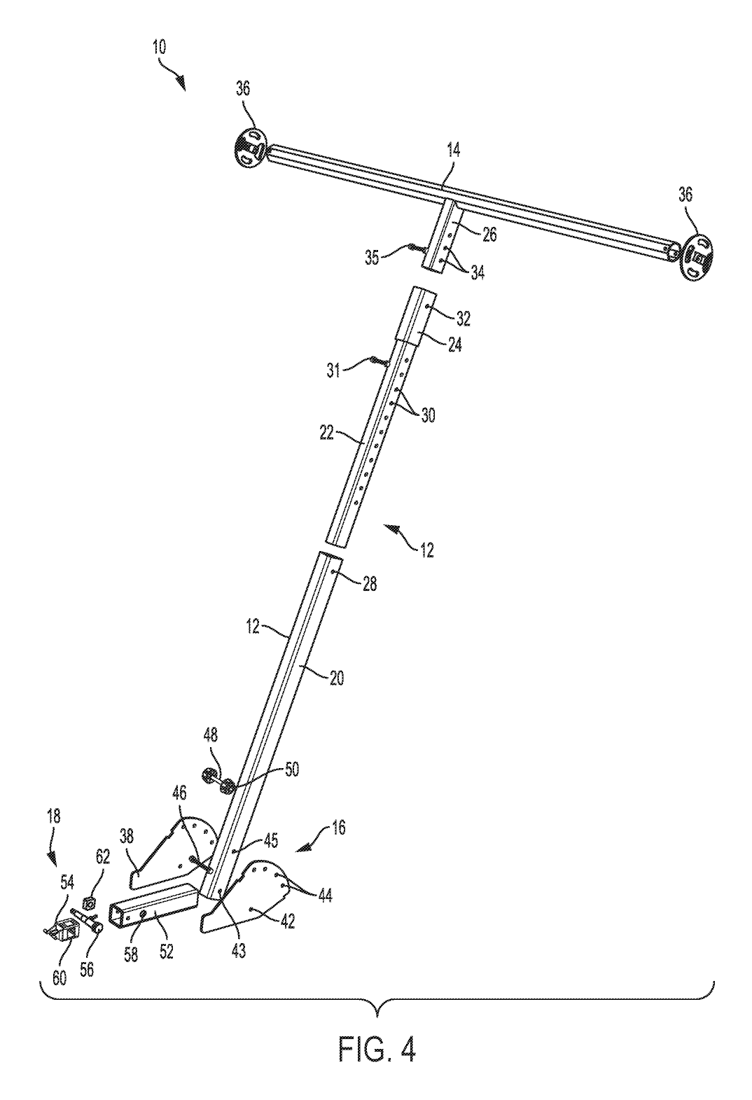

FIG. 4 shows an exploded view of truck bed extender 10. As shown, mast 12 includes multiple holes in one side of the hollow tubular mast components. Each hole through main mast sleeve 20, extender insert 22, extender sleeve 24, and crossbar support 26 corresponds to another hole in an opposing side of the mast component (not shown). Mast 12 includes multiple pairs of corresponding holes, through opposing sides of the mast. Each pair of corresponding holes may be described as forming an aperture through the mast or mast component. Each aperture extends generally parallel to crossbar 14.

Main mast sleeve 20 includes an aperture 28, and extender insert 22 includes multiple apertures 30. When assembled, a portion of extender insert 22 is received in main mast sleeve 20. One of insert apertures 30 is aligned with the main mast sleeve aperture 28, as shown in FIG. 2, and a first bolt 31 may be extended through the two aligned apertures to secure the insert relative to the main mast sleeve. A nut and washer may secure the first bolt in place. Each of the apertures 30 defines a length setting for mast 12, and the mast may be telescoped by removing the first bolt and sliding the insert in the main mast sleeve.

Similarly, extender sleeve 24 includes an aperture 32, and crossbar support 26 includes multiple apertures 34. When assembled, a portion of crossbar support 26 is received in extender sleeve 24. One of crossbar support apertures 34 is aligned with extender sleeve aperture 32 and a second bolt 35 may be extended through the two aligned apertures to secure the crossbar support relative to the extender sleeve. A nut and washer may secure the second bolt in place. Each of the apertures 34 defines a length setting for mast 12, and the mast may be telescoped by removing the second bolt and sliding the crossbar support in the extender sleeve.

Nuts may be secured on first and second bolts 31, 35 to a limited tightness, such that the bolts may be removed without the use of tools. In some examples, a hand knob or other grip may be included on the bolts and/or nuts to facilitate manual manipulation. Any appropriate fastener may be used in place of the bolts. For instance, a clevis pin may be used to secure components of mast 12. In some examples, mast 12 may be secured at a selected length by other mechanisms, such as a clamp or ratchet.

In the present example, extender insert 22 includes eleven apertures 30 and crossbar support 26 includes three apertures 34. The apertures are evenly spaced, and provide a total of 14 discrete length settings for mast 12. Any number of apertures may be included in any of the mast components, and the apertures may be spaced and/or arranged in any pattern.

Mast 12 may also be assembled with crossbar support 26 received directly in main mast sleeve 20, to achieve a shorter length of mast 12. When assembled in such a manner, one of crossbar support apertures 34 may be aligned with main mast sleeve aperture 28, and second bolt 35 extended through the two aligned apertures. To allow such flexibility in the assembly of mast 12, main mast sleeve 20 and extender sleeve 24 may have matching internal dimensions. Similarly, extender insert 22 and crossbar support 26 may have matching external dimensions.

In some examples, crossbar support 26 may have external dimensions configured to allow receipt directly in extender insert 22. Extender sleeve 24 may be omitted, with aperture 32 disposed in extender insert 22. In some examples, mast 12 may include additional extender inserts, each having multiple apertures at a first end and a sleeve with a single aperture at a second end. Mast 12 may include any number of components, assembled in any effective configuration.

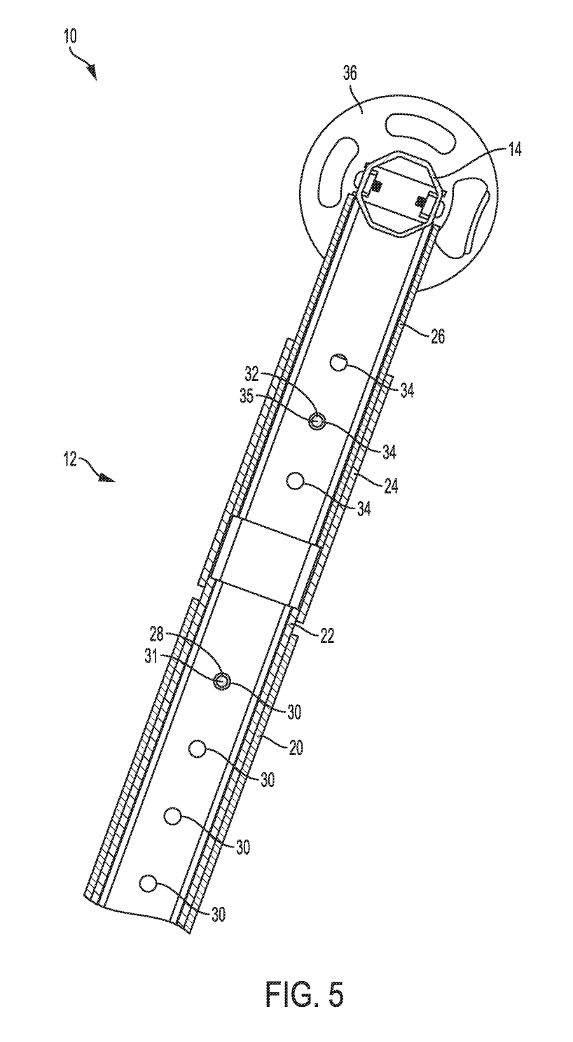

FIG. 5 shows a cross-sectional view of mast 12, assembled. Extender insert 22 is fully received in main mast sleeve 20. A distal-most aperture 30 is aligned with aperture 28 of the sleeve, and first bolt 31 secures the insert relative to the sleeve. Crossbar support 26 is partially received in extender sleeve 24, with a middle aperture 34 aligned with aperture 32 of the extender sleeve. Second bolt 35 secures the support relative to the sleeve.

Crossbar 14 is immovably fixed to crossbar support 26, at what may be referred to as an upper, and/or distal end of mast 12. A central portion of the crossbar is fixed to the mast, such that truck bed extender 10 is generally symmetrical. The cross bar is hollow, generally octagonal in cross-section, and comprised of extruded aluminum.

Circular endcaps 36, also shown in FIG. 4, are attached to each end of crossbar 14. Tabs extend from each endcap 36 into the crossbar, and are bolted to the crossbar. Multiple apertures in the endcaps are configured to be used as tie down points when securing cargo to truck bed extender 10. Endcaps 36 may have any appropriate shape, and may be fixed to crossbar 14 in any effective manner. Apertures configured for use as tie down points may be included in the end caps and/or in crossbar 14.

Crossbar 14 may have any cross-sectional shape and be manufactured of any similarly light and strong material or materials. In some examples, crossbar 14 may include additional structures and/or materials to facilitate support of cargo. For instance, crossbar 14 may include a pad of a compressible material with a high-grip surface to prevent slipping and/or damage to the underside of a boat. In some examples, crossbar 14 may be shaped to match a roof rack style crossbar such that clamps or other attachment features of recreational equipment racks may be compatible with crossbar 14.

As shown in FIG. 2, pivot assembly 16 couples mast 12 to hitch mount 18. The pivot assembly includes two flat plates 38, connected by braces 40. Plates 38 are parallel to one another, and spaced apart by the connecting braces. The plates also extend generally parallel to hitch mount 18, and may be parallel to the direction of travel of the truck when connected.

Hitch mount 18 and main mast sleeve 20 of mast 12 each extend between plates 38. A distal end of hitch mount 18 is sandwiched between the two plates, in contact with both plates and fixed to pivot assembly 16. The hitch mount may be welded, bonded, and/or otherwise coupled to one or both of plates 38. Mast 12 is coupled to plates 38 by two bolts, and pivots freely between the plates.

As shown in FIG. 4, plates 38 are matching and include corresponding pluralities of holes. Each pair of corresponding holes may be described as forming an aperture through pivot assembly 16. The pivot assembly includes a central aperture 42 and a plurality of apertures 44 arranged in an arc. The arc coincides with a circle centered at central aperture 42.

Main mast sleeve 20 includes a proximal aperture 43 disposed proximate an end of the main mast sleeve, which may be described as a bottom, and/or proximal end of mast 12. When assembled, a pivot bolt 46 extends through aperture 42 of pivot assembly 16 and proximal aperture 43 of mast 12, and is secured by a nut and washer. The mast is free to pivot about bolt 46, between plates 38. Pivot bolt 46 may not require removal for adjustment of mast 12, and may therefore be permanently secured and/or removable only by use of tools.

In some examples, mast 12 may pivot about another component of pivot assembly 16, such as a rivet, bar, or elongate protrusion of a plate 38. In some examples, mast 12 may include a structure at the bottom end, configured to facilitate a pivoting motion. For example, mast 12 may include projections on opposing sides pivotably received in the holes that make up aperture 42 of pivot assembly 16. Pivot assembly 16 and the bottom end of mast 12 may include any structures and/or be configured in any manner pivotally connecting the mast to hitch mount 18.

As shown in FIG. 4, the main mast sleeve further includes a distal aperture 45, spaced from proximal aperture 43. The two apertures are spaced by a distance matching a radius of the circle centered at central aperture 42 on pivot assembly 16. Therefore, as mast 12 pivots about bolt 46, proximal aperture 43 may be brought into alignment with each aperture 44 of the pivot assembly in turn. A partially threaded indexing bolt 48 may be extended through proximal aperture 43 and an aligned aperture 44, to prevent the mast from pivoting and thereby secure the mast relative to the pivot assembly. A nut and washer may secure the indexing bolt in place. Each aperture 44 defines a discrete angular orientation for mast 12.

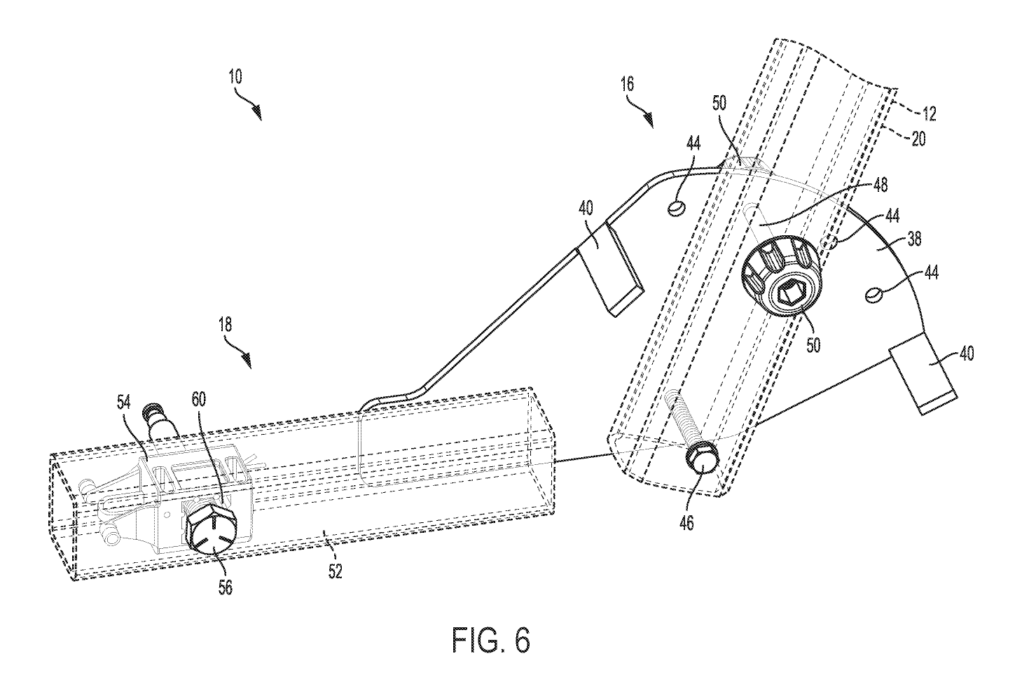

FIG. 6 shows a partially transparent view of pivot assembly 16 and hitch mount 18. One of plates 38 has been omitted to more clearly show main mast sleeve 20. A head of indexing bolt 48 and the nut securing the bolt are each received in a hand-grip knob 50. The knobs are configured to allow a user of truck bed extender 10 to easily tighten or loosen indexing bolt 48 by hand, without the use of tools. In some examples, another fastener may be used in place of the indexing bolt. For instance, a clevis pin may be used to secure mast 12. In some examples, mast 12 may be secured at a selected angle by other mechanisms, such as a clamp or ratchet.

In the present example, truck bed extender 10 is securable in four possible discrete angular orientations. The four angular orientations correspond to a range of approximately 60 degrees, through which mast 12 may pivot. The four angular orientations may be described as a 0-degree orientation, a 20-degree orientation, a 40-degree orientation, and a 60-degree orientation. As noted previously, the 0-degree orientation may be used in the storage position. Truck bed extender 10 is depicted as secured in the 20-degree orientation.

Truck bed extender 10 may be adjustable to any number of angular orientations, and mast 12 may be pivotable through any angular range. In some examples, the mast may be pivotable through a range of at least 45 degrees. In some examples, the mast may be pivotable no more than 90 degrees.

Truck bed extender 10 may include any effective hitch mount. The extender may also connect to any appropriate portion of the truck, by any effective means. In the present example hitch mount 18 includes a hollow tongue 52, a rectangular retainer 54, and a partially threaded mount bolt 56. As shown in FIGS. 4 and 6, retainer 54 has a passage that is aligned with an aperture 58 in tongue 52, allowing mount bolt 56 to extend through the tongue and the retainer. A proximal end of tongue 52 is configured to slide into the hitch receiver of the truck, such that aperture 58 aligns with corresponding holes in the hitch receiver. Mount bolt 56 may thereby extend through the hitch receiver, tongue 52, and retainer 54, and attach hitch mount 18 to the hitch receiver.

Retainer 54 includes a recess 60 configured to receive a square nut 62. A threaded portion of mount bolt 56 is threaded into nut 62, the square shape of the nut resisting rotation. An end of mount bolt 56 is shaped to receive a locking mechanism, not shown. Truck bed extender 10 may be thereby locked to the hitch receiver, to discourage theft or unauthorized removal.

Referring again to FIGS. 1 and 2, this section describes steps of an illustrative method of using truck bed extender 10. Where appropriate, reference may be made to components and systems that may be used in carrying out each step. These references are for illustration, and are not intended to limit the possible ways of carrying out any particular step of the method. Although various steps are described, the steps need not necessarily all be performed, and in some cases may be performed simultaneously or in a different order.

A user of truck bed extender 10 may first connect the extender to the hitch receiver of pickup truck 17. The user may insert tongue 52 of hitch mount 18 into the hitch receiver, and align aperture 58 of the tongue with holes in the hitch receiver. To secure the connection, the user may extend mount bolt 56 through the hitch receiver, tongue 52, and retainer 54.

Once the truck bed extender is securely connected, the user may either configure the extender for storage, or for use. To adjust the extender to the storage position, the user may first loosen indexing bolt 48 using knobs 50. After removing indexing bolt 48, the user may pivot mast 12 about pivot bolt 46 to the 0-degree orientation. With distal aperture 45 aligned with the appropriate aperture 44 of pivot assembly 16, the user may re-insert indexing bolt 48 and tighten the bolt, using knobs 50.

Subsequent or prior to adjusting the angle of mast 12, the user may adjust the mast to a shortest length. First, the user may loosen and remove first bolt 31. Sliding extender insert 22 in main mast sleeve 20, the user may align aperture 28 of the main mast sleeve with a topmost aperture 30 of the extender insert. The user may re-insert first bolt 31 through the aligned apertures, and secure with the nut. Similarly, the user may loosen and remove second bolt 35. Sliding crossbar support 26 in extender sleeve 24, the user may align aperture 32 of the extender sleeve with a topmost aperture 34 of the crossbar support. The user may re-insert second bolt 35 through the aligned apertures, and secure with the nut.

To configure truck bed extender 10 for use, the user may first select a desired location of crossbar 14. This selection may be based on dimensions of cargo to be loaded, dimensions of the truck, and/or any relevant factors. The user may adjust the angle of mast 12 as described above, removing indexing bolt 48 and pivoting mast 12 to an angular orientation best approximating the angle of the desired crossbar location.

Once mast 12 is secured at the selected angle, the user may remove first and/or second bolts 31, 35. To extend mast 12, the user may slide extender insert 22 in main mast sleeve 20 and crossbar support 26 in extender sleeve 24. Once crossbar 14 is in approximately the desired location, the user may align aperture 28 of main mast sleeve 20 with a closest aperture 30 of extender insert 22, and aperture 32 of extender sleeve 24 with a closest aperture 34 of crossbar support 26. The user may replace bolts 31, 35 to secure mast 12 at the selected length.

The user may then load cargo onto the vehicle, supporting one end of the cargo on crossbar 14. To secure the load, the user may also tie down the cargo using straps, ropes, etc. Cargo ties may be looped around crossbar 14, and or tied to the apertures in endcaps 36. When cargo is unloaded, the user may return truck bed extender 10 to the storage position as described above.

### Additional Examples and Illustrative Combinations

This section describes additional aspects and features of an adjustable truck bed extender according to the present teachings, and related systems and methods, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. A cargo support comprising:
a hitch mount configured for attachment to a vehicle;
a mast structure having a first end pivotally coupled to the hitch mount; and
a crossbar member coupled to a second end of the mast structure, perpendicular to the mast structure;
wherein a length of the mast structure and an angle of the mast structure relative to the hitch mount are separately adjustable.

A1. The cargo support of A0, wherein the mast is securable at a plurality of discrete lengths and at a plurality of discrete angles.

A2. The cargo support of A1, wherein the mast structure includes a hollow first member and a second member, with a portion of the second member slidably received in the first member.

A3. The cargo support of A2, wherein the mast structure is securable at each of the plurality of discrete lengths by a fastener extending through the first member and through the portion of the second member received in the first member.

A4. The cargo support of A1, wherein the mast structure is coupled to the hitch mount by a pivot assembly, the pivot assembly including a transverse member that extends through the mast structure and about which the mast structure is pivotable.

A5. The cargo support of A4, wherein the mast structure is securable at each of the plurality of discrete angles by a fastener extending through the pivot assembly and through the mast structure.

A6. The cargo support of A0, wherein the mast is adjustable without the use of tools.

A7. The cargo support of A0, wherein the mast is pivotable through a range of at least 45 degrees relative to the hitch mount.

A8. The cargo support of A1, wherein the mast is securable in at least 12 discrete positions, each position being a combination of a length of the plurality of discrete lengths and an angle of the plurality of discrete angles.

B0. A truck bed extender comprising:
a hitch mount configured for attachment to a hitch receiver behind a truck;
a mast pivotably coupled to the hitch mount and configured to extend in a plane including a line defined by a longitudinal extent of the truck; and
a crossbar coupled to the mast;
wherein the mast is configured to pivot between a plurality of discrete angles and to telescope between a plurality of discrete lengths.

B1. The truck bed extender of B0, wherein, when the hitch mount is attached to the hitch receiver, the mast is adjustable to:
a first position such that the crossbar is disposed at a first height corresponding to a bed of the truck;
a second position such that the crossbar is disposed at a second height corresponding to a bed rail of the truck; and
a third position such that the crossbar is disposed at a third height corresponding to a cab of the truck.

B2. The truck bed extender of B0, wherein the mast is coupled to the hitch mount by a transverse member.

B3. The truck bed extender of B0, wherein the mast is secured at one of the plurality of discrete angles by a first transverse member the mast is secured at one of the plurality of discrete lengths by a second transverse member.

B4. The truck bed extender of B2, wherein the transverse member is a bolt.

C0. A rack for carrying cargo on a vehicle, comprising:
a tongue member having a long axis, a proximal end portion configured for engaging a hitch receiver on the rear of a truck, and a distal end portion connected to a pivot assembly,
a mast structure having a long axis, a proximal end portion and a distal end portion, the proximal end portion being pivotally connected to the pivot assembly, wherein the pivot assembly permits selective adjustment of an angle formed between the long axis of the tongue member and the long axis of the mast structure, and
a crossbar connected to the distal end of the mast structure.

C1. The rack of C0, wherein the distal end portion of the mast structure includes a telescoping mechanism for adjusting an effective length of the mast structure.

C2. The rack of C1, wherein the telescoping mechanism allows adjustment of the distance between the pivot assembly and the crossbar.

C3. The rack of C1, wherein the mast structure includes a first tube member and a second tube member variably received in the first tube member.

C4. The rack of C1, wherein the mast structure includes a third tube member having a proximal end and a distal end, the proximal end of the third tube member being variably received in the second tube member

D0. A rack for carrying cargo on a vehicle, comprising:
a tongue member having a long axis, a proximal end portion configured for engaging a hitch receiver on the rear of a truck, and a distal end portion, and
a mast structure connected to the tongue member, the mast structure having a long axis, a proximal end portion, and a distal end portion connected to a crossbar, wherein the mast structure includes first, second, and third telescopically engaged tube portions, the first tube portion being pivotally connected to the pivot assembly, the second tube member being telescopically engaged with the first tube member, and the third tube member being telescopically engaged with the second tube member.

D1. The rack of D0, wherein each of the second and third tube members has a proximal end portion configured to engage a distal end of the first tube member.

D3. The rack of D0, wherein the mast structure is connected to the tongue member via a pivot assembly.

D4. The rack of D3, wherein a length of the mast structure and an angle of the mast structure relative to the tongue member are separately adjustable.

D5. The rack of D3, wherein the pivot assembly permits selective adjustment of an angle formed between the long axis of the tongue member and the long axis of the mast structure.

### CONCLUSION

It is believed that the disclosure set forth herein encompasses multiple distinct inventions with independent utility. While each of these inventions has been disclosed in its preferred form, the specific examples thereof as disclosed and illustrated herein are not to be considered in a limiting sense as numerous variations are possible. The subject matter of the disclosure includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

The various structural members disclosed herein may be constructed from any suitable material, or combination of materials, such as metal, plastic, nylon, plastic, rubber, or any other materials with sufficient structural strength to withstand the loads incurred during use. Materials may be selected based on their durability, flexibility, weight, and/or aesthetic qualities.

Although the present disclosure has been provided with reference to the foregoing operational principles and examples, it will be apparent to those skilled in the art that various changes in form and detail may be made without departing from the spirit and scope of the disclosure. The present disclosure is intended to embrace all such alternatives, modifications and variances. Furthermore, any aspect shown or described with reference to a particular example should be interpreted to be compatible with any other example, alternative, modification, or variance.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

What is claimed is:

1. A cargo support rack for a vehicle, comprising:
a hitch mount configured for attachment to a vehicle;
a mast structure having a first end pivotally coupled to the hitch mount; and
a crossbar member coupled to a second end of the mast structure, perpendicular to the mast structure;
wherein a length of the mast structure and an angle of the mast structure relative to the hitch mount are separately adjustable.

2. The cargo support of claim 1, wherein the mast is securable at a plurality of discrete lengths and at a plurality of discrete angles.

3. The cargo support of claim 2, wherein the mast structure includes a hollow first member and a second member, with a portion of the second member slidably received in the first member.

4. The cargo support of claim 3, wherein the mast structure is securable at each of the plurality of discrete lengths by a fastener extending through the first member and through the portion of the second member received in the first member.

5. The cargo support of claim 2, wherein the mast structure is coupled to the hitch mount by a pivot assembly, the pivot assembly including a transverse member that extends through the mast structure and about which the mast structure is pivotable.

6. The cargo support of claim 5, wherein the mast structure is securable at each of the plurality of discrete angles by a fastener extending through the pivot assembly and through the mast structure.

7. The cargo support of claim 1, wherein the mast structure is adjustable without the use of tools.

8. The cargo support of claim 1, wherein the mast structure is pivotable through a range of at least 45 degrees relative to the hitch mount.

9. The cargo support of claim 2, wherein the mast structure is securable in at least 12 discrete positions, each position being a combination of a length of the plurality of discrete lengths and an angle of the plurality of discrete angles.

10. A rack for carrying cargo on a vehicle, comprising:
a tongue member having a long axis, a proximal end portion configured for engaging a hitch receiver on the rear of a truck, and a distal end portion connected to a pivot assembly,
a mast structure having a long axis, a proximal end portion and a distal end portion, the proximal end portion being pivotally connected to the pivot assembly, wherein the pivot assembly permits selective adjustment of an angle formed between the long axis of the tongue member and the long axis of the mast structure, and
a crossbar connected to the distal end of the mast structure.

11. The rack of claim 10, wherein the distal end portion of the mast structure includes a telescoping mechanism for adjusting an effective length of the mast structure.

12. The rack of claim 11, wherein the telescoping mechanism allows adjustment of the distance between the pivot assembly and the crossbar.

13. The rack of claim 11, wherein the mast structure includes a first tube member and a second tube member variably received in the first tube member.

14. The rack of claim 13, wherein the mast structure includes a third tube member having a proximal end and a distal end, the proximal end of the third tube member being variably received in the second tube member

15. The rack of claim 10, wherein the long axis of the mast structure remains in a plane bisecting the truck.

16. A rack for carrying cargo on a vehicle, comprising:
a tongue member having a long axis, a proximal end portion configured for engaging a hitch receiver on the rear of a truck, and a distal end portion, and
a mast structure connected to the tongue member, the mast structure having a long axis, a proximal end portion, and a distal end portion connected to a crossbar, wherein the mast structure includes first, second, and third telescopically engaged tube portions, the first tube portion being pivotally connected to the pivot assembly, the second tube portion being telescopically engaged with the first tube portion, and the third tube portion being telescopically engaged with the second tube portion.

17. The rack of claim 16, wherein each of the second and third tube portions has a proximal end portion configured to engage a distal end of the first tube portion.

18. The rack of claim 16, wherein the mast structure is connected to the tongue member via a pivot assembly.

19. The rack of claim 18, wherein a length of the mast structure and an angle of the mast structure relative to the tongue member are separately adjustable.

20. The rack of claim 18, wherein the pivot assembly permits selective adjustment of an angle formed between the long axis of the tongue member and the long axis of the mast structure.
